(19) United States
(12) Patent Application Publication
(10) Pub. No.: US 2020/0317432 A1
(43) Pub. Date: Oct. 8, 2020

(54) APPARATUS FOR CONSUMING A FREEZABLE SUBSTANCE

(71) Applicant: LIQR POP, LLC, Henderson, NV (US)

(72) Inventors: Tracy Reinhardt, Henderson, NV (US); William Robert Reinhardt, JR., Henderson, NV (US); Dale Constuble, Helendale, CA (US); Renato Valz-Brenta, Eastvale, CA (US); Tony Balmforth, Yucaipa, CA (US); Doug Bjork, Rancho Cucamonga, CA (US)

(21) Appl. No.: 16/772,725

(22) PCT Filed: Nov. 18, 2018
(86) PCT No.: PCT/US2018/061878

§ 371 Date: Jun. 12, 2020

Related U.S. Application Data
(60) Provisional application No. 62/599,520, filed on Dec. 15, 2017.

(51) Int. Cl. B65D 85/60; A23G 9/08; A23G 9/28

(52) U.S. Cl. CPC B65D 85/60; A23G 9/28; A23G 9/083

(57) ABSTRACT

An apparatus for consuming a freezable substance is disclosed. The apparatus can comprise a squeezable chamber configured to store a liquid. The apparatus can comprise a flange coupled to or formed with the squeezable chamber, the flange sized and shaped to support the freezable substance. The apparatus can comprise a liquid pathway from the squeezable chamber through the flange to deliver the liquid to the freezable substance.

### CROSS-REFERENCE TO RELATED APPLICATIONS

This application claims priority to U.S. Provisional Patent Application No. 62/599,520, filed Dec. 15, 2017, the entire contents of which are incorporated by reference herein in their entirety and for all purposes.

### BACKGROUND

### Field

The present disclosure relates generally to an apparatus for consuming a freezable substance, e.g., a frozen confection or frozen beverage device. More specifically, the present disclosure relates to a device for forming a frozen confection that allows for simultaneous consumption of the frozen confection and a user-controlled quantity of fluid, such as alcohol or another liquid.

### Description of the Related Art

People sometimes desire to consume mixtures of freezable substances and liquids, such as alcohol, cannabis oil, liquid medication, hydration liquids, liquid vitamins, liquid energy drinks, flavored liquids, or any other suitable liquid base. For example, people desire cool refreshments, especially during the hot summer months. Frozen confections, such as ice pops and Popsicles®, are well-known and popular summertime refreshments for people of all ages. A great variety of frozen confection products, having different colors, flavors, textures, fat content, and caloric content, are widely available. In addition to frozen confections, frozen cocktails are well-known and popular summertime refreshments enjoyed by adults. Frozen cocktails are popular in part because they are cold and also because they are alcoholic.

Freezing alcoholic beverages is problematic due to the low freezing point of ethyl alcohol (the alcohol in alcoholic beverages), which is approximately −173° F. under ambient conditions. The freezing point of alcoholic beverages is between the freezing points of water (32° F.) and alcohol (−173° F.), and depends on the beverage's alcohol content. Therefore, it is difficult to freeze alcoholic beverages and confections having higher alcohol content. As such, completely frozen confections such as ice pops and Popsicles® generally do not contain alcohol.

Because of the low freezing point of alcohol, popular frozen cocktails such as margaritas, piña coladas, and daiquiris are far from completely frozen when served. Instead, “frozen” cocktails are served as a slush with ice crystals suspended in the liquid. If the frozen cocktail is not quickly consumed, the ice crystals melt causing the cocktail to have a less desirable texture and temperature.

In addition to frozen cocktails, it is known to mix alcohol with gelatin to produce food products commonly referred to as Jello® shots and pudding shots. For instance, one type of product mixes vodka, or other alcoholic beverage, with a prepared gelatin before the gelatin solidifies or hardens. The gelatin is then chilled and hardens with the alcoholic beverage contained therein. Although these alcoholic gelatin products provide an alternative to frozen cocktails, they too are not completely frozen and therefore not as refreshing as completely frozen refreshments.

In view of the foregoing, there remains a need in the art for a device that allows for simultaneous consumption of the frozen confection and an alcoholic beverage. The present disclosure addresses this particular need, as discussed in detail below.

### SUMMARY

In one embodiment, an apparatus for consuming a freezable substance is disclosed. The apparatus can comprise a squeezable chamber configured to store a liquid. The apparatus can comprise a flange coupled to or formed with the squeezable chamber, the flange sized and shaped to support the freezable substance. The apparatus can comprise a liquid pathway from the squeezable chamber through the flange to deliver the liquid to the freezable substance.

In another embodiment, an apparatus for consuming a freezable substance is disclosed. The apparatus can comprise a squeezable chamber configured to store a liquid. The apparatus can comprise a freezable substance disposed over the squeezable chamber. The apparatus can comprise a liquid pathway from the squeezable chamber to the freezable substance to deliver the liquid to the freezable substance when a squeezing force is applied to the squeezable chamber.

In another embodiment, a method of consuming a freezable substance is disclosed. The method can comprise squeezing a squeezable chamber in which a liquid is contained, such that the liquid exits the squeezable chamber and mixes with the freezable substance. The method can comprise consuming the freezable substance and the liquid.

In another embodiment, an apparatus for consuming a freezable substance. The apparatus can include a flange sized and shaped to support the freezable substance. The flange can include a projection extending from a first side of the flange. The flange can include a channel in a first side of the flange. The flange can include an orifice providing fluid communication between the first side and a second side of the flange, the first side opposite the second side, the channel sloped to deliver liquid to the orifice. A liquid pathway can extend through the orifice and the projection, the liquid pathway supplying the liquid to the freezable substance.

In another embodiment, an apparatus for consuming a freezable substance is disclosed. The apparatus can include a flange sized and shaped to support the freezable substance, the flange comprises a cavity and a raised rim disposed about the cavity. The apparatus can include one or a plurality of posts extending from a floor of the cavity at a first side of the flange. The apparatus can include a liquid pathway extending through the flange, the liquid pathway supplying liquid to the freezable substance by way of an opening at an upper portion of the flange.

### BRIEF DESCRIPTION OF THE DRAWINGS

FIG. 1 is a schematic perspective view of a device for preparing, storing, and serving a chilled or frozen item.

FIG. 2 is a schematic side view of the device with the cap having been removed from the device.

FIG. 3 is a schematic bottom perspective view of the cap.

FIG. 4 is a schematic side sectional view of the handle, according to various embodiments.

FIG. 5 is an enlarged schematic side sectional view of a portion of the handle shown in FIG. 4.

FIG. 5A is a schematic side sectional view of the handle, according to another embodiment.

FIG. 6 is a schematic top perspective view of the device of FIG. 1 with the cap removed.

### DETAILED DESCRIPTION

The present disclosure relates to a device for molding a freezable substance and dispensing a stored fluid substance. More specifically, the present disclosure relates to a device that, when assembled, creates a Popsicle®-like frozen confection having a container holding a liquid. The user can squeeze a flexible, squeezable chamber to drive the liquid upward through a lumen in the frozen confection so that the user may simultaneously consume the frozen confection and ingest the liquid. Thus, the device allows for a liquid and a frozen substance to be ingested simultaneously while being contained separately within a single vessel. The device further allows the user to control the amount of liquid ingested, and thus the flavor of the product. Using the squeezable chamber, the user may shoot liquid from the device, drizzle the liquid over the frozen confection, or refrain from ingesting any liquid at all. Throughout all the embodiments disclosed herein, the fluid (e.g., stored fluid) can comprise any suitable fluid, e.g., liquid. In various embodiments, the liquid can comprise alcohol, cannabis oil, liquid medicine, hydration liquids, liquid vitamins, liquid energy drinks, flavored liquids, or any other suitable liquid bases.

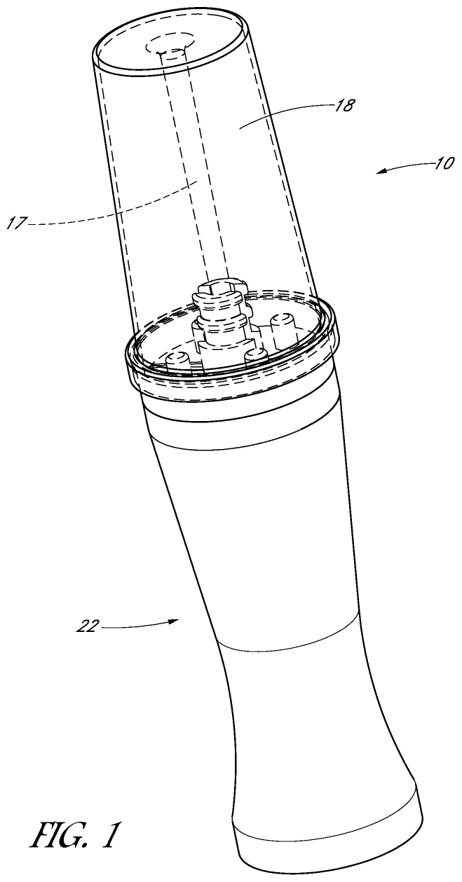

The drawings are for purposes of illustrating a preferred embodiment of the present disclosure, and not for purposes of limiting the same. FIG. 1 is a schematic perspective view of a device 10 for preparing, storing, and serving a chilled or frozen item. As shown in FIG. 1, the device 10 can comprise a handle 2.2 and a cap 18 removably connected to an upper portion of the handle 22. As explained herein, the handle 22 can comprise one or more chambers that store a fluid, such as an alcoholic beverage, cannabis oil, medication, hydration liquids, liquid vitamins, liquid energy drinks, flavored liquids, etc. A frozen confection (not shown in FIG. 1) can be provided inside the cap 18.

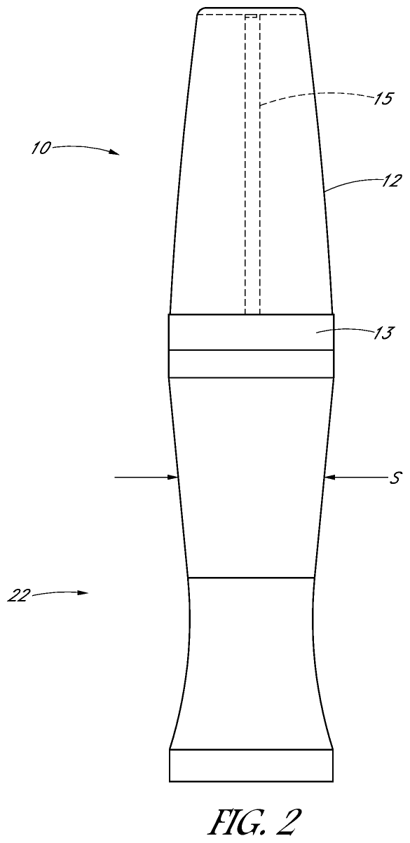

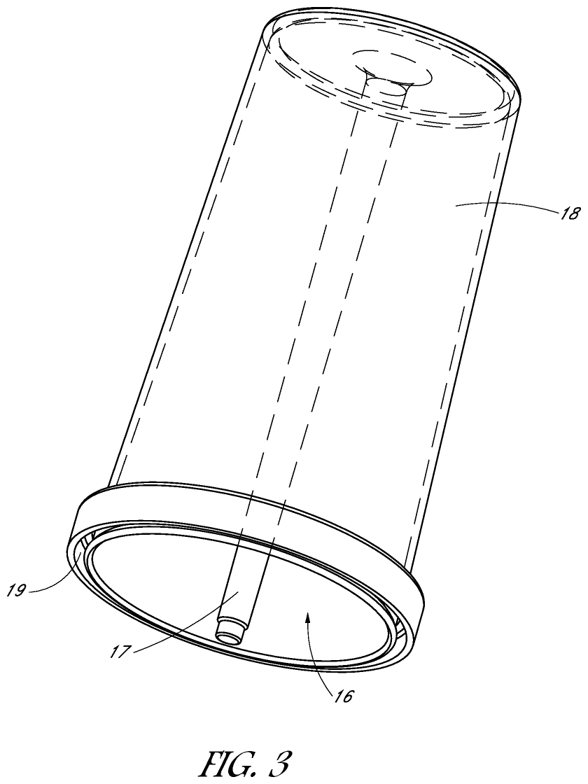

FIG. 2 is a schematic side view of the device 10 with the cap 18 having been removed from the device 10 to reveal a freezable or frozen confection 12. FIG. 3 is a schematic bottom perspective view of the cap 18. As shown in FIGS. 1 and 3, the cap 18 can comprise a mold cavity 16 sized and shaped to define the freezable confection 12 and to contain and/or protect the freezable confection 12. In various embodiments, the freezable confection 12 can be formed by providing a liquid (e.g., water or a flavored liquid) within the mold cavity 16 between the cap 18 and the handle 22. The liquid can be frozen to form the freezable confection 12. Still other ways of forming the freezable confection 12 may be suitable. The cap 18 can removably connect to the handle 22 by way of an engagement feature, such as an annular groove 19. The groove 19 can removably engage with a flange 13 coupled to or formed with an upper portion of the handle 22. For example, in some embodiments, the groove 19 can snap onto the flange 13 to removably connect the cap 18 to the handle 22. The user can remove and/or replace the cap 18 from and/or to the handle 22 by pulling the cap 18 from or snapping the cap 18 to the handle 22.

As shown in FIGS. 1 and 3, the cap 18 can comprise an elongate plug 17 extend from an upper surface of the cap 18. The plug 17 can comprise a rod, shaft, or other suitable elongate member. As shown in FIG. 3, the plug 17 can have a length that is at least half a length of the cap 18. In some embodiments, such as that shown in FIGS. 1 and 3, the plug 17 can be longer than the cap 18 along a direction parallel to the plug 17. The freezable confection 12 can be provided around the plug 17. As shown in FIG. 2, when the cap 18 is removed from the handle 22, a lumen 15 can be provided through the freezable confection 12 in the space through which the plug 17 previously extended. As explained herein, upon squeezing the handle 22, the stored fluid can be delivered to and/or over the frozen confection 12 through the lumen 15. The fluid can mix with the frozen confection to provide the user with a tasty treat (or dose of medicine, etc.). Thus, in the illustrated embodiment, the device 10 is configured to allow a person to simultaneously consume the frozen confection 12 and the fluid (such as alcohol, cannabis oil, medications, flavored liquids, etc.).

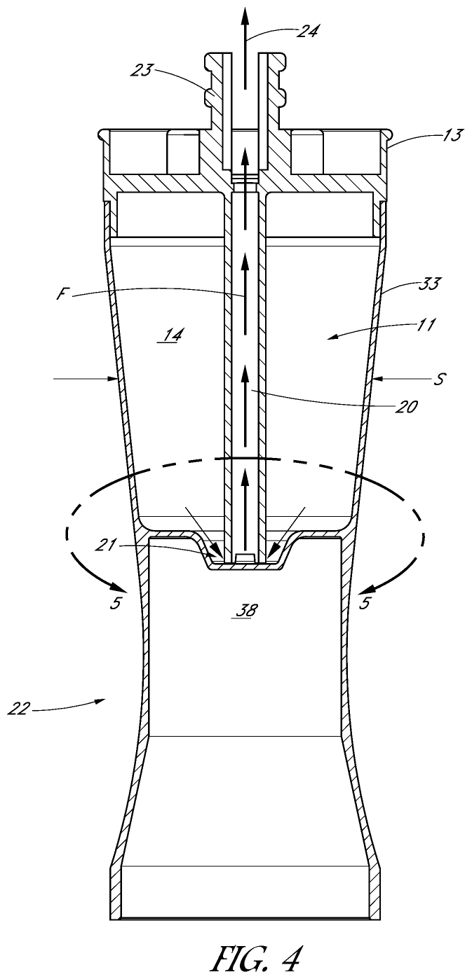

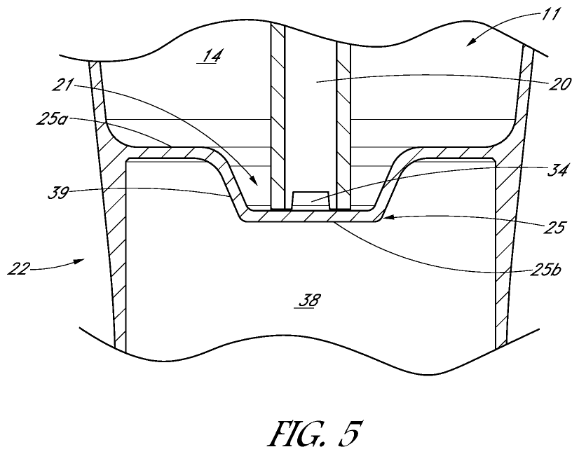

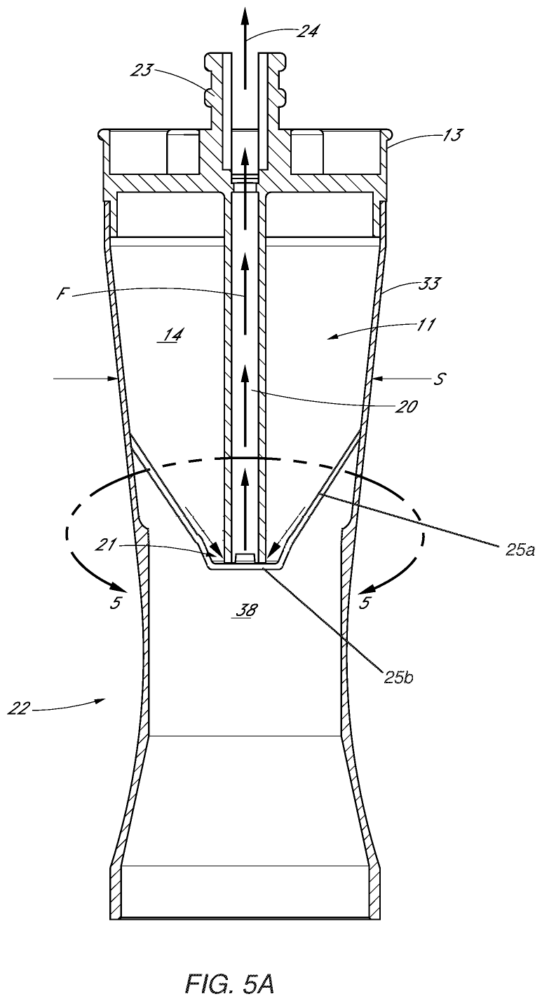

FIG. 4 is a schematic side sectional view of the handle 22, according to various embodiments. FIG. 5 is an enlarged schematic side sectional view of a portion of the handle 22 shown in FIG. 4. The handle 22 can comprise a first chamber 11 and a second chamber 38. As shown in FIG. 5, the first and second chambers 11, 38 can be separated by a partition 25. The first chamber 11 can comprise a squeezable chamber sized and shaped to store a fluid 14. As explained herein, the fluid 14 can comprise a liquid such as an alcoholic beverage, cannabis oil, liquid medication, hydration liquids, liquid vitamins, liquid energy drinks, flavored liquids, or any other suitable liquid. The second chamber 38 can be used for any suitable purpose, including, e.g., acting as an enclosure for other device components, such as processing electronics (e.g., communications chips), optical emitters, batteries, etc.

It can be important to size the first chamber 11 (which is configured to store the fluid 14) relative to the mold cavity 16 (which is sized to contain the freezable confection 12) in such a manner as to provide the user with a mixture of fluid 14 and freezable confection 12 at a relative concentration that is pleasing to taste. For example, in embodiments in which the fluid 14 comprises an alcoholic beverage, it may be desirable to provide a mixed confection having alcoholic content in a range of 20 proof to 40 proof, e.g., about 30 proof. In some embodiments, the volume V_{M} of the mold cavity 16 of the cap 18 and the volume V_{C} of the first chamber 11 can be selected to provide the user with a pleasant taste. In some embodiments, the volume V_{M} of the mold cavity 16 can be in a range of 30 mL to 100 mL, in a range of 30 mL to 75 mL, in a range of 35 mL to 70 mL, in a range of 35 mL to 60 mL, in a range of 35 mL to 55 mL, in a range of 40 mL, to 55 mL, in a range of 40 mL to 50 mL, or in a range of 42 mL to 46 mL, e.g., about 44 mL in one embodiment.

As explained above, the first chamber 11 can be squeezable, e.g., the first chamber 11 can be defined by a wall 33 that can be made of a flexible or deformable material, such as a polymer or plastic. In some embodiments, the wall 33 of the chamber 11 can comprise a thermoplastic elastomer (TPE) material. Since the first chamber 11 is squeezable, the volume V_{C} of the chamber 11 may be variable. In various embodiments, the volume V_{C} of the first chamber 11 can have a maximum volume (e.g., a volume when not deformed or squeezed) in a range of 35 mL to 100 mL, in a range of 35 mL to 75 mL, in a range of 40 mL to 70 mL, in a range of 45 mL to 65 mL, or in a range of 50 mL to 60 mL, e.g., about 56 mL in some embodiments. In various embodiments, the mold cavity 16 can have a volume V_{M} that is large than the volume V_{C} of the chamber 11. In various embodiments, it can be advantageous (in terms of providing a good taste to the user) to shape the mold cavity 16 and the first chamber 11 to have volumes that are in accordance with a volume ratio R defined as the ratio V_{M}:V_{C}, as defined relative to the maximum volume of the chamber 11. In some embodiments, the ratio R can be in a ratio of 0.5 to 1.2, in a range of 0.5 to 1, in a range of 0.5 to 0.9, in a range of 0.6 to 0.9, in a range of 0.65 to 0.85, in a range of 0.7 to 0.85, in a range of 0.73 to 0.83, or in a range of 0.75 to 0.8.

As shown in FIGS. 4 and 5, a tube 20 can extend downwardly from the flange 13 into the first chamber 11. In some embodiments, the tube 20 can extend to and be coupled with the partition 25 between the chambers 11, 38. One or a plurality of ports 34 can be provided so that the fluid 14 can pass from the first chamber 11 into the tube 20 by way of the port(s) 34. In FIG. 4, the first chamber 11 can comprise fluid inlet region 21 that can act as a funnel to direct the fluid 14 into the tube 20 from the first chamber 11. As shown in FIGS. 4 and 5, the partition 25 can include one or more angled portions 39 that act as a funnel at or around the fluid inlet region 21. For example, as shown in FIG. 5, the angled portion 39 can taper radially inwardly from an upper portion 25a of the partition 25 to a lower portion 25b of the partition 25 so as to improve the flow of liquid into the port(s) 34.

When the user is ready to consume the freezable confection 12, the user can remove the cap 18, and apply a radially-inward squeezing force S to the walls 33 of the handle 22. The squeezing force S in turn applies pressure to the fluid 14 in the first chamber 11 to cause the fluid 14 to enter the tube 20 through the port(s) 34. As shown in FIG. 4, the fluid 14 can follow a flow pathway F, in which the fluid 14 can enter the tube 20 and pass upwardly through the tube 20 and the flange 13. As shown in FIG. 4, the flange 13 can comprise a projection 23 having an opening 24 at the upper end of the projection. As shown, the projection 23 can extend from a first (e.g., upper) side of the flange 13. The tube 20 can extend from a second (e.g., lower) side of the flange 13 opposite the first side. The fluid 14 can pass from the tube 20 through the opening 24 of the projection 23, and out over the freezable confection 12 (not shown in FIGS. 4-5). The fluid 14 can intermix with the freezable confection to provide the user with a pleasant taste.

FIG. 5A is a schematic side sectional view of the handle 22, according to another embodiment. Unless otherwise noted, the components of the device shown in FIG. 5A may be the same as or generally similar to like-numbered components of FIGS. 1-5. As shown in FIG. 5A, for example, a partition 25 can be provided to separate the chambers 11, 38. The partition 25 can comprise an upper portion 25a and a lower portion 25b. Unlike the embodiment shown in FIGS. 4-5, however, the upper portion 25a can comprise a sloped surface or wall that extends from the lower partition 25b to the wall(s) 33 of the handle 22 at an angle. In some embodiments, the upper portion 25a can comprise a generally planar or straight wall that extends to the wall 33. In other embodiments, the upper portion 25a can be curved, for example, in a generally parabolic shape.

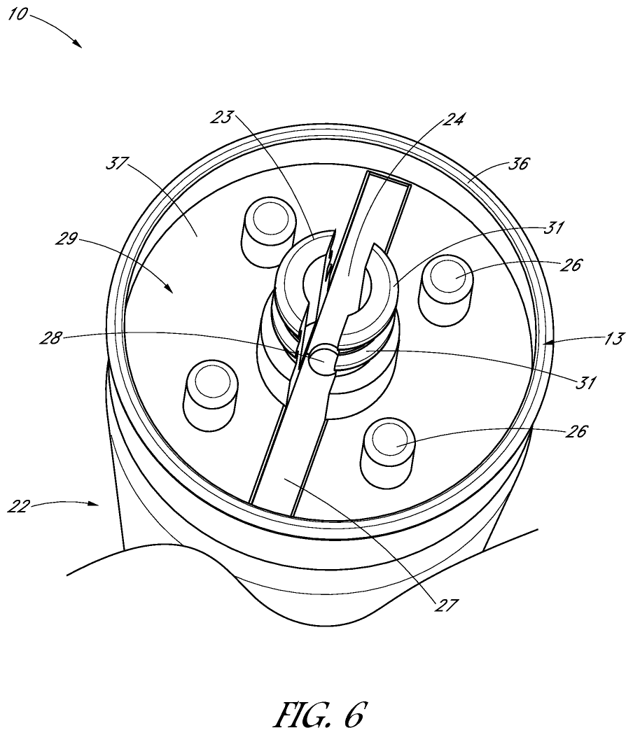

FIG. 6 is a schematic top perspective view of the device 10. As shown in FIG. 6, the flange 13 can be coupled to (e.g., snapped within) or formed with (e.g., integrally formed with) the handle 22. The flange 13 can comprise a raised rim 36 that defines a cavity 29 in which the lower portion of the frozen confection 12 is supported. The flange 13 can comprise various components configured to secure the frozen confection 12 to the device and/or to prevent rotation of the frozen confection 12 relative to the cap 18 or handle 22. For example, as shown in FIG. 6, the flange 13 can comprise a plurality of posts 26 extending upwardly in the cavity 29 from a floor 37 of the flange 13. The frozen confection 12 can freeze about the posts 26 to provide additional contact between the flange 13 and the confection 12. The posts 26 can thereby provide improved support to the frozen confection 12. Moreover, the projection 23 can comprise one or a plurality of ribs 31 extending radially outward from the projection 23. As shown in FIG. 6, the ribs 31 can extend circumferentially about the projection 23. As with the posts 26, the ribs 31 can help secure the frozen confection 12 to the flange 13.

In addition, in FIG. 6, the flange 13 can comprise a channel 27 extending along the floor 37 between the projections 23. Beneficially, the channel 27 can provide a drain pathway for liquids to drain into the first chamber 11 through a drain hole or orifice 28 between the cavity 29 and the tube 20. In some embodiments, the channel 27 can be sloped downwardly towards the orifice 28 so as to guide the liquid to the orifice 28. Thus, liquids (such as the fluid 14 or melted liquid from the frozen confection 12) can drain into the channel 27 and can pass through the orifice 28 to enter the first chamber 11. Beneficially, therefore, the orifice 28 and channel 27 can enable melted or otherwise unconsumed liquid to re-mix with the fluid 14 in the chamber 11, rather than spilling out of the cavity 29 over the raised rim 36. Furthermore, before use, the elongate plug 17 of the cap 18 can extend through the opening 24 and can plug the orifice 28, thereby preventing the fluid 14 from spilling out of the device 10 when not being used. The orifice 28 can serve as an inlet through which the liquid is supplied to the opening 24 (e.g., when the liquid is pressurized, for example, by squeezing the squeezable chamber) and the freezable confection, as well as an outlet or drain hole in which unconsumed liquid can pass back into the chamber 11.

The device 10 can include other structures to enhance the usability of the device 10. For example, in various embodiments, the device 10 can comprise an attachment point for a lanyard, which the user can use to hand the device 10 around his or her neck, etc. In various embodiments, the handle 22 can comprise any other suitable type of attachment structure that enables the user to attach the handle 22 to the user (e.g., to the user's hat, clothing, accessories, etc.) before or after the fluid and frozen substances have been consumed. The user can therefore removably connect the handle 22 to the user's clothing or accessories in various embodiments.

For purposes of summarizing the disclosed embodiments and the advantages achieved over the prior art, certain objects and advantages have been described herein. Of course, it is to be understood that not necessarily all such objects or advantages may be achieved in accordance with any particular embodiment. Thus, for example, those skilled in the art will recognize that the disclosed implementations may be embodied or carried out in a manner that achieves or optimizes one advantage or group of advantages as taught or suggested herein without necessarily achieving other objects or advantages as may be taught or suggested herein.

All of these embodiments are intended to be within the scope of this disclosure. These and other embodiments will become readily apparent to those skilled in the art from the following detailed description of the embodiments having reference to the attached figures, the claims not being limited to any particular embodiments) disclosed. Although this certain embodiments and examples have been disclosed herein, it will be understood by those skilled in the art that the disclosed implementations extend beyond the specifically disclosed embodiments to other alternative embodiments and/or uses and obvious modifications and equivalents thereof. In addition, while several variations have been shown and described in detail, other modifications will be readily apparent to those of skill in the art based upon this disclosure. It is also contemplated that various combinations or sub-combinations of the specific features and aspects of the embodiments may be made and still fall within the scope. It should be understood that various features and aspects of the disclosed embodiments can be combined with, or substituted for, one another in order to form varying modes of the disclosed implementations. Thus, it is intended that the scope of the subject matter herein disclosed should not be limited by the particular disclosed embodiments described above, but should be determined only by a fair reading of the claims that follow.

What is claimed is:

1. An apparatus for consuming a freezable substance, the apparatus comprising:
a squeezable chamber configured to store a liquid;
a flange coupled to or formed with the squeezable chamber, the flange sized and shaped to support the freezable substance; and
a liquid pathway from the squeezable chamber through the flange to deliver the liquid to the freezable substance.

2. The apparatus of claim 1, wherein the liquid pathway comprises a tube extending from the flange into the squeezable chamber.

3. The apparatus of claim 2, further comprising one or more ports through the tube to provide fluid communication between an interior of the tube and the squeezable chamber.

4. The apparatus of any one of claims 1 to 3, further comprising a second chamber separated from the squeezable chamber by a partition, the squeezable chamber between the second chamber and the flange.

5. The apparatus of claim 4, further comprising one or more electronic components in the second chamber.

6. The apparatus of any one of claims 1 to 5, wherein the flange comprises a cavity and a raised rim disposed about the cavity.

7. The apparatus of claim 6, further comprising one or a plurality of posts extending from a floor of the cavity.

8. The apparatus of any one of claims 6 to 7, further comprising a projection extending through the cavity, the cavity having an opening at an end portion, the liquid pathway passing through the opening.

9. The apparatus of claim 8, further comprising one or a plurality of ribs extending radially outward from the projection.

10. The apparatus of claim 9, wherein the one or the plurality of ribs extend circumferentially about the projection.

11. The apparatus of any one of claims 6 to 10, further comprising a channel and an orifice in a floor of the cavity, the channel sloped to deliver liquid to the orifice.

12. The apparatus of claim 11, wherein the orifice is in fluid communication with the squeezable chamber.

13. The apparatus of any one of claims 1 to 12, further comprising the liquid, the liquid stored in the squeezable chamber.

14. The apparatus of any one of claims 1 to 13, further comprising the freezable confection, the freezable confection supported by the flange.

15. The apparatus of claim 14, further comprising a lumen extending from the flange through the freezable confection.

16. The apparatus of any one of claims 14 to 15, further comprising a cap disposed over the freezable confection, the cap removably coupled with the flange.

17. The apparatus of claim 16, further comprising an elongate plug extending from an upper portion of the cap to the flange.

18. The apparatus of claim 17, wherein the elongate plug has a length that is at least half a length of the cap.

19. The apparatus of claim 18, wherein the elongate plug is longer than the cap.

20. An apparatus for consuming a freezable substance, the apparatus comprising:
a squeezable chamber configured to store a liquid;
a freezable substance disposed over the squeezable chamber;
a liquid pathway from the squeezable chamber to the freezable substance to deliver the liquid to the freezable substance when a squeezing force is applied to the squeezable chamber.

21. The apparatus of claim 20, further comprising a cap disposed over the freezable substance.

22. The apparatus of claim 21, wherein the cap comprises an elongate plug extending from an upper portion of the cap.

23. The apparatus of claim 22, wherein the elongate plug has a length that is at least half a length of the cap.

24. A method of consuming a freezable substance, the method comprising:
squeezing a squeezable chamber in which a liquid is contained, such that the liquid exits the squeezable chamber and mixes with the freezable substance; and
consuming the freezable substance and the liquid.

25. The method of claim 24, further comprising removing a cap from over the freezable substance prior to the squeezing.

26. The method of any one of claims 24 to 25, further comprising directing the liquid through a tube extending into the squeezable chamber, through a flange that supports the freezable substance, and through a lumen extending through the freezable substance.

27. An apparatus for consuming a freezable substance, the apparatus comprising:
a flange sized and shaped to support the freezable substance, the flange comprising:
a projection extending from a first side of the flange;
a channel in a first side of the flange; and
an orifice providing fluid communication between the first side and a second side of the flange, the first side opposite the second side, the channel sloped to deliver liquid to the orifice; and
a liquid pathway extending through the orifice and the projection, the liquid pathway supplying the liquid to the freezable substance.

28. The apparatus of claim 27, further comprising a tube extending from the second side of the flange, the liquid pathway extending through the tube.

29. The apparatus of claim 27 or 28, further comprising a squeezable chamber to store the liquid, the flange coupled to or formed with the squeezable chamber, the liquid pathway extending from the squeezable chamber through the flange to deliver the liquid to the freezable substance.

30. The apparatus of claim 28, further comprising one or more ports through the tube to provide fluid communication between an interior of the tube and the squeezable chamber.

31. The apparatus of any one of claims 27 to 30, wherein the flange comprises a cavity and a raised rim disposed about the cavity.

32. The apparatus of any one of claims 27 to 31, further comprising one or a plurality of posts extending from a floor at the first side of the flange.

33. The apparatus of any one of claims 27 to 32, further comprising one or a plurality of ribs extending radially outward from the projection.

34. The apparatus of claim 33, wherein the one or the plurality of ribs extend circumferentially about the projection.

35. An apparatus for consuming a freezable substance, the apparatus comprising:
a flange sized and shaped to support the freezable substance, the flange comprises a cavity and a raised rim disposed about the cavity;
one or a plurality of posts extending from a floor of the cavity at a first side of the flange and
a liquid pathway extending through the flange, the liquid pathway supplying liquid to the freezable substance by way of an opening at an upper portion of the flange.

36. The apparatus of claim 35, wherein the flange comprises a projection extending from the first side of the flange and a tube extending from a second side of the flange, the first side opposite the second side.

37. The apparatus of any one of claims 35 to 36, further comprising one or a plurality of ribs extending radially outward from the projection.

38. The apparatus of claim 37, wherein the one or the plurality of ribs extend circumferentially about the projection.
